(19) United States
(12) Patent Application Publication
(10) Pub. No.: US 2002/0067858 A1
(43) Pub. Date: Jun. 6, 2002

(54) System, method and computer program product for extracting quantitative summaries of information from images

(76) Inventor: Emmanuel Lazaridis, Tampa, FL (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/858,977

(22) Filed: May 17, 2001

Related U.S. Application Data
(60) Provisional application No. 60/204,772, filed on May 17, 2000.

(51) Int. Cl. G06K 9/62

(52) U.S. Cl. 382/228

(57) ABSTRACT

A system, process, and computer program product for extracting quantitative summaries of information from digital images includes performing a first image analysis and one or more additional image analyses. The first image analysis comprises quantitating an image to obtain data from the image. Similarly, the one or more additional image analyses comprise modifying the first image analysis or replacing the first image analysis with one or more other image analyses, and wherein performing the one or more additional image analyses comprises quantitating the image to obtain data which may differ from the first image analysis. In addition, the present invention includes performing a mathematical analysis following completion of the first and the one or more additional image analyses on the data obtained from the first image analysis and from the one or more additional image analyses, or performing a mathematical analysis after each image analysis on the data obtained from the first image analysis and from the one or more additional image analyses, wherein the mathematical analysis comprises producing one or more inferences from the data obtained above, wherein the one or more inferences comprise quantitative summaries of information derived from the data. In this manner, the present invention combines imaging and mathematical analysis in a single process. Consequently, imaging analysis is advantageously not segregated from mathematical analysis.

### RELATED APPLICATIONS

This patent application is related to U.S. Provisional patent application Ser. No. 60/204,772, filed May 17, 2000, which is incorporated herein by reference in its entirety, including all references cited therein.

### 1. FIELD OF THE INVENTION

The present invention relates generally to a system, method and computer program product for extracting information from digital images. More particularly, the present invention relates to a system, method and computer program product which integrates advanced mathematical procedures and imaging techniques to extract quantitative summaries of information from digital images.

### 2. BACKGROUND OF THE INVENTION

Images in general, and digital images in particular, have long been used to represent information for use in a wide variety of contexts. For example, images and sets of images are commonly utilized in fields ranging from finance to satellite imagery, and even in areas concerning molecular biology, such as, for instance, microarrays, microscopy and proteomics. Various imaging models and techniques are then used to extract useful information from the images. Subsequently, one of a number of mathematical models may be used to process the pieces of information extracted from these digital images to result in the production of inferences, or quantitative summaries of information from the data.

Whatever the case may be, in each instance an image or a set of images is derived by a primary investigator—for example, a biologist or pathologist—in an experimental context. Then, to draw informative research conclusions from the images, the steps of quantitation, analysis, and interpretation are performed. In today's research environment, the primary investigator usually directs quantitation, or the extraction of data, from the images. In addition, quantitation may be enhanced by interaction with imaging scientists. The resulting data is then given to a statistician or other numerical analyst, who then performs the actual analysis.

Many systems are available for imaging or image analysis including home-grown and commercial, general and special purpose packages such as Optimas (Media Cybernetics, Inc.; general purpose imaging), SpotFinder (TIGR; microarray slide imaging) and CAROL (Free University of Berlin; proteomics 2-D gel imaging), to name but a few. Indeed, many vendors of biological equipment produce and distribute their own software, which they bundle with their equipment. While some of the available packages may provide sophisticated image-analysis tools, no mathematical methods are typically available in such systems for analysis of the resulting data.

Conversely, popular mathematical analysis packages such as SAS, SPSS and S-Plus, while providing sophisticated models for data analysis, lack any facility for image quantitation. Instead, these packages typically rely on other systems, namely the systems mentioned above, for the production or quantitation of data, upon which they are subsequently employed to perform mathematical analyses. Thus, in the prior art, the process of imaging has been detrimentally segregated from the mathematical analytical process.

A general example of a prior art process utilizing segregated imaging and mathematical analyses is described with reference to FIGS. 1A and 1B. These processes generally commence with the production of an image, upon which an image analysis using, one of the packages mentioned above is performed 104. Typically this image analysis is performed by an imaging specialist, who does not typically interact with a data analyst during the image analysis process. Referring to FIG. 1B, image analysis 104 may include image refinement 112 followed by the actual quantitation of the image 116 for the production of data. After quantitation 116, the image is checked for sufficient refinement 120. If the image is not sufficiently refined, processing returns to step 112 for additional image refinement. On the other hand, if the image is sufficiently refined, data are produced, and processing continues with data analysis by, for example, a statistician or numerical analyst, 108 resulting in inference. However, the analysis performed by the statistician or numerical analyst typically does not account for the process by which data were extracted by the imaging specialist. Thus, reasonable adjustments for the peculiarities of any specific image analysis are not made during the mathematical analysis.

As one specific example of such a prior art process, reference is made to a microarray experiment conducted by biologist. In this case, the identification of a relatively small set of genes implicated in the biological process being studied is of particular interest. The biologist first completes the experiment and then provides one or more sets of slides to an imaging scientist. The imaging scientist image-analyzes, or in other words, quantitates the slides, thereby producing data from the slides. The data are then supplied to a mathematical analyst or statistician, who analyses or, as in this case, seeks classes of up-regulated expressed genes without any assistance from the imaging scientist. Thus, the mathematical analyst builds a model for the data that does not account for the details of the imaging process.

With this prior art process, unless the mathematical analyst notices a trend suspiciously correlated with chip geometry, the quantitation process is never revisited. No consideration is made regarding the effects of the imaging parameters on the quantitation. Likewise, no consideration is made regarding how changes in the image-analytic quantitation algorithms may affect the statistical conclusions. Furthermore, no consideration is made regarding the fact that different imaging algorithms function in many ways to make reasonable adjustments for such features as signal bleeding and other chip or image anomalies.

As another example, consider a pathologist evaluating a biomarker for lung cancer in an experiment in which biopsy samples whose cancer potential is unknown are stained and compared to stained positive and negative controls. If controls are derived from cell cultures, they may have very different staining characteristics from biopsy material, so the pathologist instead employs samples from biopsies of known pedigree as staining controls. These controls are paired on slides with a test sample, stained, and image-analyzed at various times over the course of approximately a year. The degree of staining for each tested sample is, in addition, adjusted for the degree of staining of the appropriate control.

In this scenario, after the pathologist completes the experiment, the slides are imaged and image-analyzed in conjunction with an imaging scientist. In particular, a sophisticated image-analysis procedure may be used to adjust the data for cellular heterogeneity in positive and negative controls, and for differences in staining effectiveness across the experiment. Furthermore, different imaging parameters would typically be employed in different runs of the image analysis system to optimize the quality of the data. Data are then obtained and taken to an analyst, who characterizes the effectiveness of the biomarker by building a model for the data that does not account for details of the imaging process.

Consequently, this model fails to consider what effects the imaging parameters had on the quantitation, and how changes in the image-analytic quantitation algorithms affect the statistical conclusions. Again, biases are often subtle and difficult to identify. Even so, the mathematical model of the data is not capable of adjusting to imaging choices that may affect the analysis in subtle ways. With this particular example, it is conceivable that the new biomarker will eventually be employed in clinical contexts, and yet traditional models fail to link the imaging procedures and parameters to biomarker performance in a manner which could identify improvements in the technique prior to its implementation in the clinic.

As a final example, a biologist, interested in discovering proteins associated with a specific cellular signaling pathway, tags proteins from cells treated with different inhibitors and enhancers of that pathway and analyses in parallel 2-D proteomics gels. Upon developing the images, it is noted that the protein spots do not line up across the gels because of uncontrolled gel-specific inhomogeneities.

In this example, the biologist first completes the experiment. The membranes or gels produced from the experiment are then imaged and image-analyzed in conjunction with an imaging scientist. In this regard, any one of a number of sophisticated imaging algorithms is employed to identify related spots across the images. From there, the data are taken to an analyst, who identifies the one or two important protein spots that should be extracted from the gels for sequencing. Protein sequencing is an expensive and time-consuming process, and it is extremely important that the best candidate spots be chosen. However, once again, the analyst in this example builds a model for the data that does not account for details of the imaging process.

Hence, the process in this example fails to consider what effect the particular imaging algorithm may have had on the data, and consequently, on the statistical results. Different algorithms have different error rates in spot matching. In addition, no algorithms exist in the literature that adjust the spot intensities after deformation of an image, so even if the spots were correctly aligned, the resulting data might still be biased in relation to the extent of deformation, which may differ in different regions of the images. Furthermore, with this example, it is unclear whether adjustment for the degree of deformation affects the statistical conclusions.

Thus, in each of the above examples, even though the entire research team may have participated in interpreting the results of mathematical analysis, their conclusions are only as good as the analytic model allows. To be more specific, the segregation of the imaging from analysis, especially in the context of the analysis of image-related data, is sub-optimal.

Thus, it is apparent that a scientific segregation of the analysis of data from the process by which image-related data are obtained exists in the systems and methods of the prior art. While these prior art methods and systems may suffice to conduct the kinds of traditional biological experimental methods that relied primarily on qualitative examination of images, the use of such methods and systems in the context of the new biological methods being explored by modem investigators will not suffice.

Accordingly, it is apparent that a need exists for a system, method and computer program product that does not segregate imaging from mathematical analysis. In particular, a need exists for a system, method and computer program product that combines imaging and mathematical analysis in a single process.

Furthermore, a need exists for a system, method and computer program product that considers the fact that different imaging algorithms function in many ways to make reasonable adjustments for such features as signal bleeding and other chip or image anomalies.

In addition, a need exists for a system, method and computer program product that considers the effects of the imaging parameters on the quantitation, and how changes in the image-analytic quantitation algorithms affect the statistical conclusions.

### 3. SUMMARY OF THE INVENTION

To address the above and other needs of the prior art, it is an object of the present invention to provide a novel system, method, and computer program product that combines imaging and mathematical analysis in a single process. As a result, imaging analysis is not segregated from mathematical analysis.

It is also an object of the present invention to provide a system, method and computer program product that considers the effects of the imaging parameters on the quantitation.

It is also an object of the present invention to provide a system, method and computer program product that considers how changes in the image-analytic quantitation algorithms may affect the statistical conclusions.

It is another object of the present invention to provide a system, method and computer program product that considers the fact that different imaging algorithms function in many ways to make reasonable adjustments for such features as signal bleeding and other chip or image anomalies.

To meet these and other objects, the present invention provides a system, process, and computer program product for extracting quantitative summaries of information from digital images. In one embodiment, the invention includes: (a) performing a first image analysis and one or more additional image analyses, wherein the first image analysis comprises quantitating an image to obtain data from the image, and the one or more additional image analyses comprise modifying the first image analysis or replacing the first image analysis with one or more other image analyses, and wherein performing the one or more additional image analyses comprises quantitating the image to obtain data which may differ from the first image analysis; and (b) performing a mathematical analysis following completion of the first and the one or more additional image analyses on the data obtained from the first image analysis and from the one or more additional image analyses, or performing a mathematical analysis after each image analysis in step (a) on the data obtained from the first image analysis or from the one or more additional image analyses, wherein the mathematical analysis comprises producing one or more inferences from the data obtained in step (a), the one or more inferences comprising quantitative summaries of information derived from the data.

There has thus been outlined, rather broadly, several important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### 4. NOTATIONS AND NOMENCLATURE

The detailed descriptions which follow may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include digital computers or similar devices.

The present invention also relates to an apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

### 5. BRIEF DESCRIPTION OF THE FIGURES

FIG. 1A illustrates a prior art process which utilizes segregated image and mathematical analyses for the production of inferences;

FIG. 1B illustrates an image analysis technique of the process of FIG. 1;

FIG. 2 illustrates one example of a process implementable for extracting quantitative summaries of information from digital images according to the principles of the present invention;

FIG. 3A illustrates one example of a process for executing an imaging experiment utilizable in the process of FIG. 2;

FIG. 3B illustrates another example of a process for executing an imaging experiment utilizable in the process of FIG. 2;

FIG. 4 illustrates one example of a process for selecting an imaging experiment utilizable in the processes of FIGS. 3A and 3B;

FIG. 5A illustrates one example of a geometrization algorithm utilizable in the process of FIG. 4;

FIG. 5B illustrates another example of a geometrization algorithm utilizable in the process of FIG. 4;

FIG. 6 illustrates one example of a process for performing a first or additional image analysis utilizable in the process of FIG. 3A;

FIG. 7 illustrates one example of a process for performing a mathematical analysis utilizable in the process of FIG. 3A;

FIG. 8 illustrates one example of a process for performing a mathematical analysis utilizable in the process of FIG. 3B;

FIG. 9 illustrates one example of a process for performing another mathematical analysis utilizable in the process of FIG. 3B;

FIG. 10 illustrates one example of a process for combining mathematical analyses utilizable in the process of FIG. 3B;

FIG. 11 is a representation of a main central processing unit for implementing the computer processing of FIG. 2 in accordance with one embodiment of the present invention;

FIG. 12 is a block diagram of the internal hardware of the computer illustrated in FIG.

FIG. 13 is an illustration of an exemplary memory medium which can be used with the disk drives illustrated in FIGS. 11 and 12;

FIG. 14A illustrates one example of a combined Internet, POTS, and ADSL architecture which may be used to implement the computer processing depicted in FIG. 2 in accordance with one embodiment of the present invention;

FIG. 14B illustrates one example of an Internet 2 architecture which may be used to implement the computer processing depicted in FIG. 2 in accordance with one embodiment of the present invention;

FIG. 15 depicts a block diagram representation of an alternate architecture utilizable for implementing the computer processing of FIG. 2 in accordance with another embodiment of the present invention;

FIG. 16 depicts a block diagram representation of yet another alternate architecture utilizable for implementing the computer processing of FIG. 2 in accordance with yet another embodiment of the present invention;

FIG. 17 depicts one example of a process employed to calculate estimates of parameters from Bayesian statistical models using a sampling approach;

FIG. 18 depicts one example of an application of multichain monitored algorithms employed to discover solutions for Bayesian statistical models;

FIG. 19 illustrates a ClonTech filter utilized in a microarray experiment;

FIG. 20 illustrates a portion of a NEN Micromax slide;

FIG. 21 illustrates a portion of an Affymetrix chip;

FIG. 22 illustrates a hybridization of Cy3 and Cy5 labeled probes to a region of a 19,200-element human array from TIGR;

FIG. 23 illustrates a specimen tracking system integrating molecular biology findings from a number of laboratories;

FIG. 24 illustrates an ethidium bromide stained 2-D proteomics gel; and

FIG. 25 illustrates that phosphorylated and non-phosphorylated versions of a protein occur at different locations on a 2-D proteomics gel.

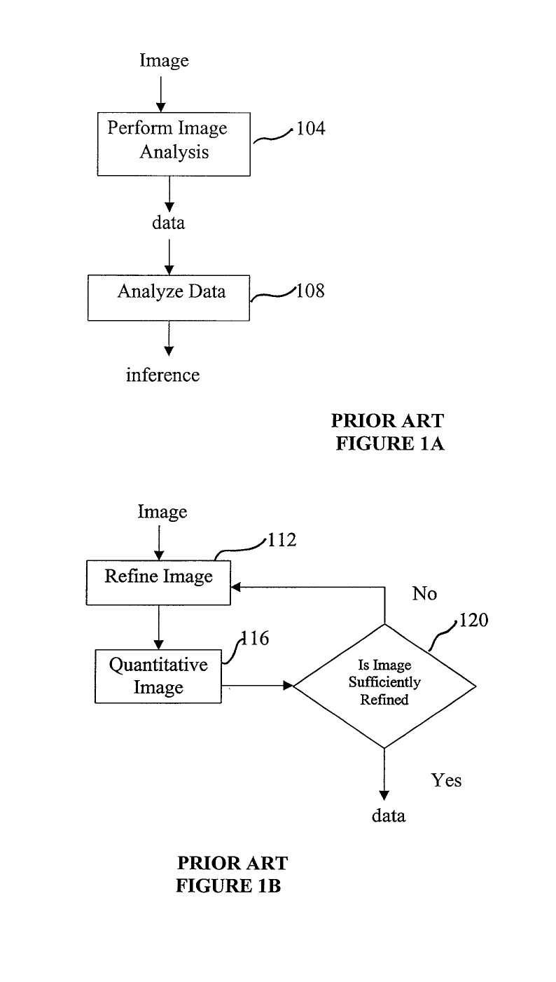

### 6. DETAILED DESCRIPTION OF THE PREFERRED EMBODIMENTS

In accordance with the principles of the present invention, a method, system and computer program product for extracting quantitative summaries of information from digital images includes performing a first image analysis and one or more additional image analyses, wherein the first image analysis comprises quantitating an image to obtain data from the image. Similarly, the one or more additional image analyses comprise modifying the first image analysis or replacing the first image analysis with one or more other image analyses, and wherein performing the one or more additional image analyses comprises quantitating the image to obtain data which may differ from those obtained in the first image analysis. In addition, the present invention includes performing a mathematical analysis following completion of the first and the one or more additional image analyses on the data obtained from the first image analysis and from the one or more additional image analyses, or performing a mathematical analysis after each image analysis on the data obtained from the first image analysis and from the one or more additional image analyses, wherein the mathematical analysis comprises producing one or more inferences from the data obtained above, wherein the one or more inferences comprise quantitative summaries of information derived from the data. In this manner, the present invention combines imaging and mathematical analysis in a single process. Consequently, imaging analysis is not segregated from mathematical analysis.

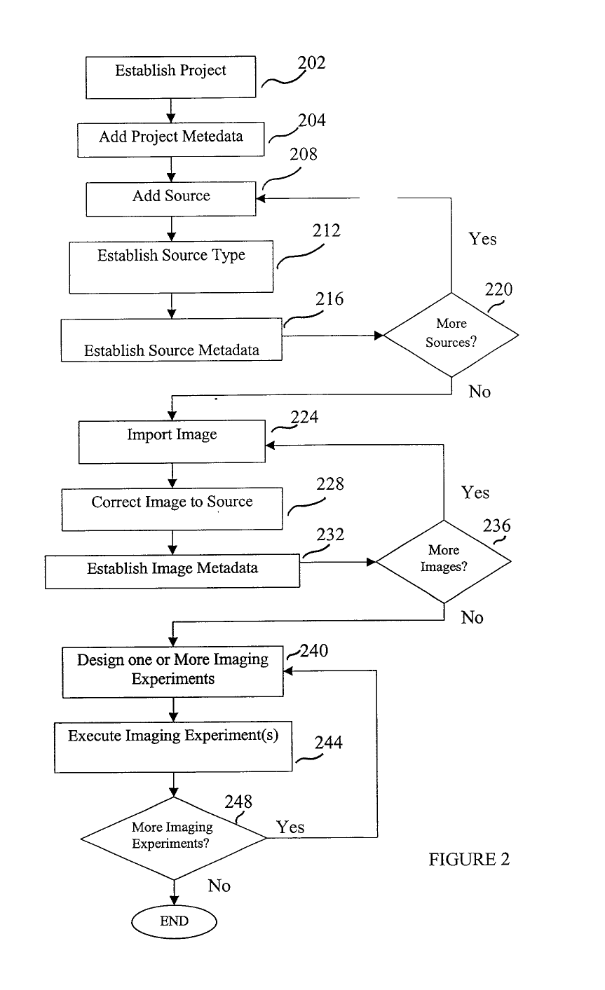

In accordance with the principles of the present invention, one example of a system and/or process used to implement the technique of the present invention is depicted in FIG. 2. Processing commences with the establishment of a project 202, which serves to tie together a set of sources and images that are stored in a database. In this context, a project encompasses a set of sources that have a set of images. Thus, the project could include pictures or photographs taken from a weather satellite of a hurricane. Similarly, it could be multiple pictures from microarray chips or from a pair of 2-D proteomics gels, or the like. Project metadata is optionally added to describe the project 204.

Subsequent to the establishment of a project 202, a source is added 208. As will be discussed below, an image is derived from each of the added sources. Thus, using the 2-D gel example mentioned above, in an experiment with two gels, each gel would serve as a source. Then a type 212, and, optionally, additional source metadata 216 are established for the source added in 208. The metadata established here differs from the metadata established at 204 in that it is specific to the added source. Utilizing this procedure, any number of sources can be added via feedback loop 220.

After the desired number of sources has been added, processing shifts to the addition of associated images. First, an image which was, for example, previously scanned into the system, is imported 224. Next, the imported image is connected, or in other words mapped, to a source 228. By doing so, the process advantageously accounts for sources that may have multiple images associated therewith. For example, a single source may have multiple images generated therefrom using a laser scan at distinct intensities, or a particular film source may have been used to produce several images each having different exposures times, or multiple satellite images of a hurricane may have been obtained over a period of time.

Subsequent to importing an image, metadata for the image may be established 232. Specifically, particularities of the image may be included, such as, for instance image properties, how the image was scanned, and parameters relating to the scanning technique. Additional images may then be added following the process described above via feedback loop 236.

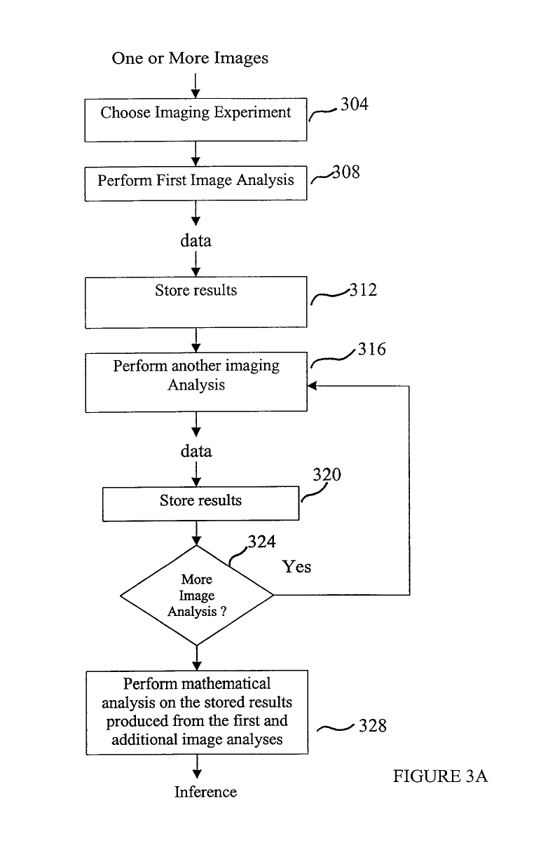

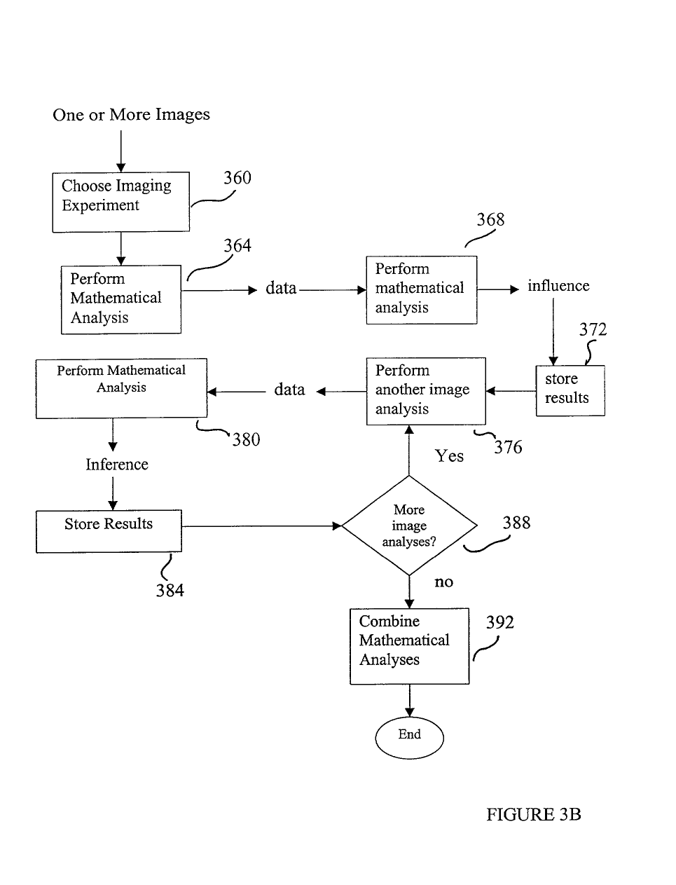

From there, in accordance with the principles of the present invention, processing continues with designing one or more imaging experiments 240, and with a step of executing the imaging experiments 224, which will be described in greater detail below with reference to FIGS. 3A and 3B. Furthermore, any number of additional imaging experiments 248 may be performed utilizing feedback loop 248. According to the principles of the invention, the execution of the imaging experiments in step 244 advantageously integrates or combines the imaging and mathematical analysis in a single process. Consequently, the imaging analysis is not segregated from the mathematical analysis.

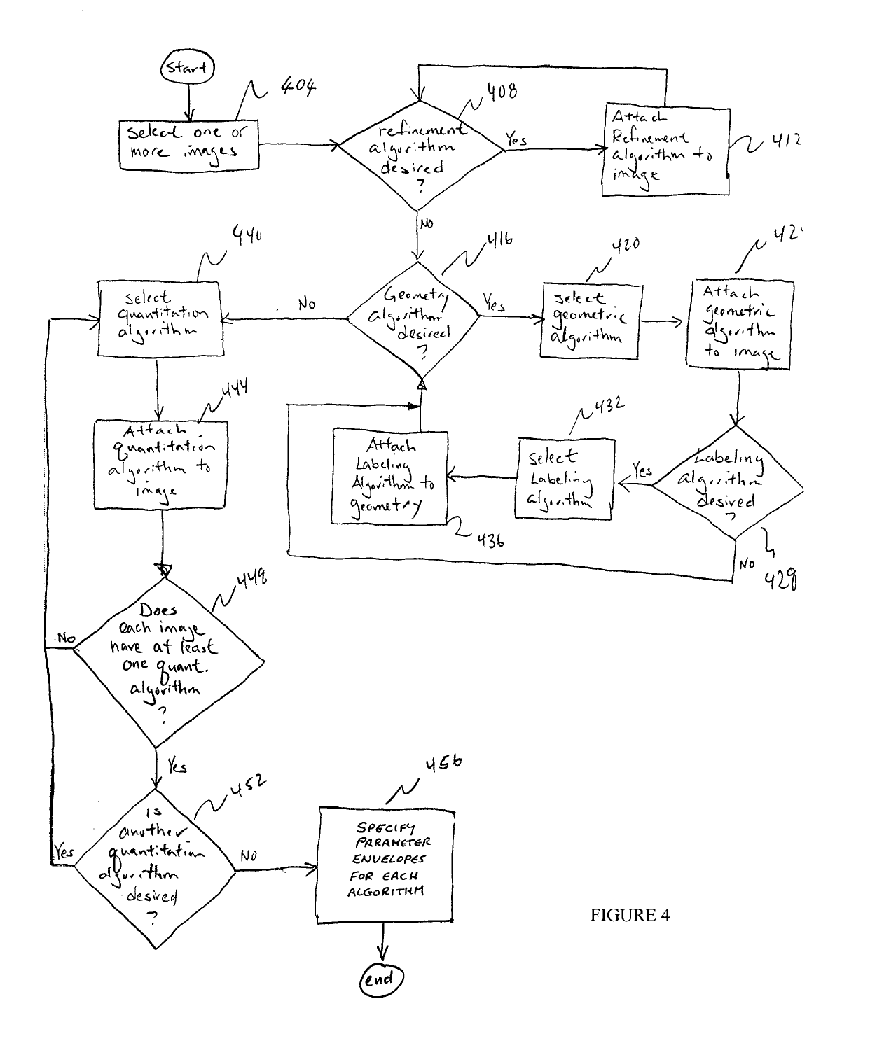

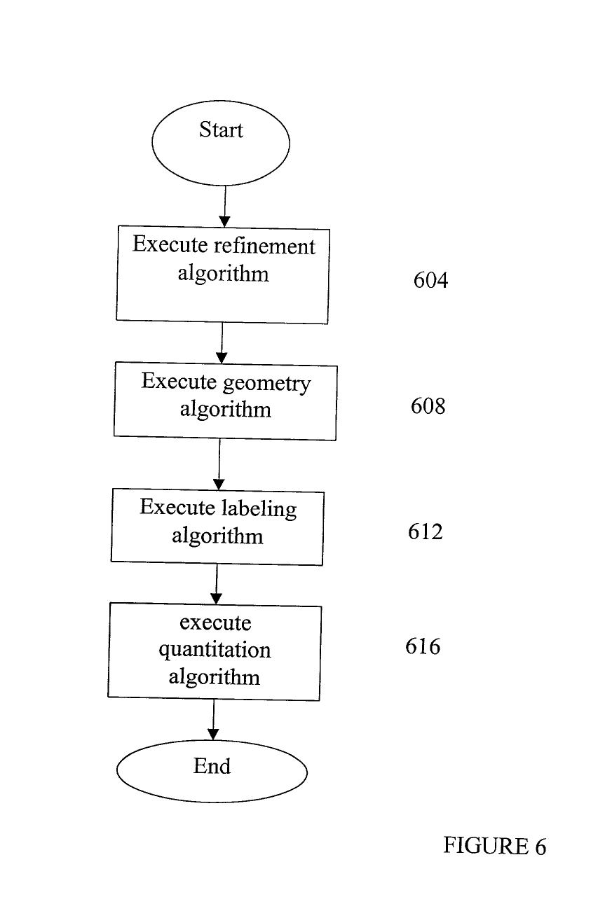

Referring to FIGS. 3A and 3B, the process of executing the imaging experiments 244 mentioned above will now be discussed. Turning first to FIG. 3A, as one example, the imaging experiment execution commences with the selection of an imaging experiment 304. As will be discussed in greater detail below and with reference to FIG. 4, selection of an imaging experiment 304 includes a number of processes such as, for instance, refining the image, applying a geometrization algorithm, and applying quantitation algorithms. After selection of an imaging experiment, a first image analysis is performed 308. The image analysis basically quantitates an image resulting in the production of data and will be discussed in greater detail below with reference to FIG. 6. The data produced from the first image analysis are then stored 312, and processing continues with the performance of another imaging analysis 316 (discussed below with reference to FIG. 6), storing the results 320, and determining whether additional image analyses are required 324, until image analysis is complete. In accordance with the principles of the present invention, these additional image analyses performed at 316 advantageously comprise a modification of the first image analysis in 308, or a complete replacement of the original image analysis with an entirely different analysis or sets of analyses. Any additional analyses performed also result in the production of data, which may or may not resemble the data produced with the first analysis. Then, once the image analyses have been completed, a mathematical analysis is performed on the stored results 328. As a result, according to the concepts of the present invention, the imaging and mathematical analysis are integrated into a single process.

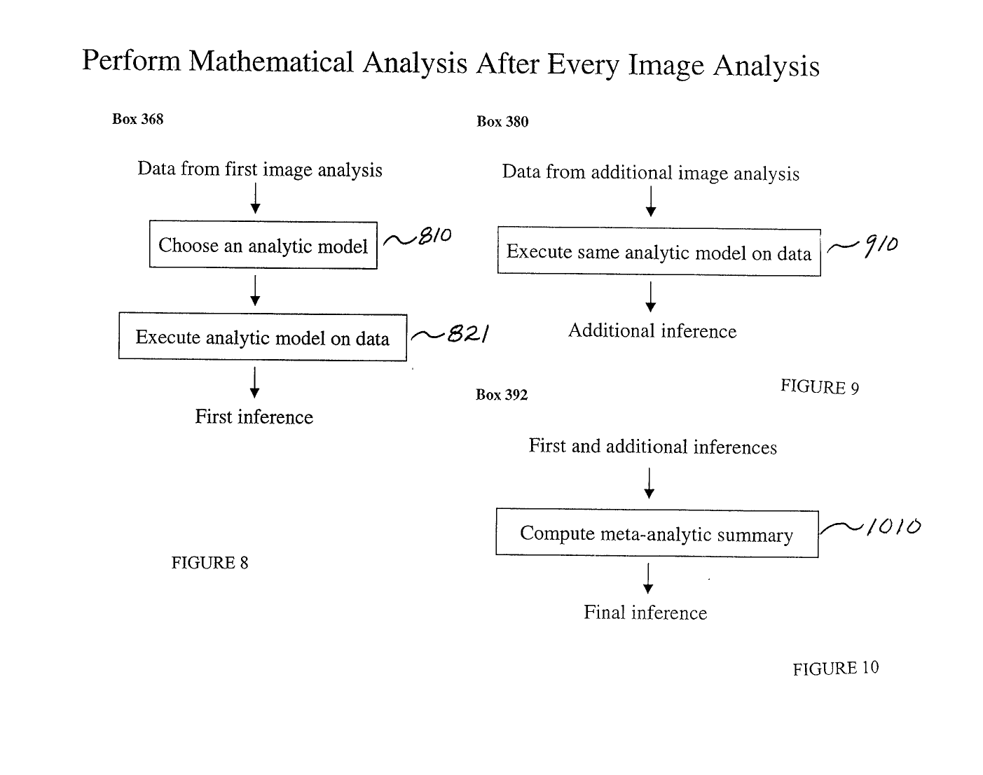

In an alternate embodiment depicted in FIG. 3B, in contrast to the example discussed above, a mathematical analysis is performed after each image analysis. In particular, like the embodiment described above, processing begins with the selection of an imaging experiment 360 followed by performing a first image analysis 364 to produce data. The imaging experiment selection 360 here is similar to the selection mentioned above and is also described below with reference to FIG. 4. Image analysis 364, on the other hand, is discussed in greater detail below with reference to FIG. 8. Subsequent to image analysis 364, a first mathematical analysis is performed 368 resulting in the production of an inference, which is then stored in, for example, a database of the system 372. After the results of the first mathematical analysis have been stored, another image analysis is performed 376, similarly producing data. The data produced, in turn, become the subject of another mathematical analysis 380 resulting in the production of an inference which is likewise stored in a database 384. Additional image analyses may then be performed as determined according to feedback loop 388. Finally, as will be discussed in greater detail below with reference to FIG. 10, when all of the desired image analyses have been performed, the results of the mathematical analyses are combined 392. Consequently, as with the above example, the imaging and mathematical analysis are integrated into a single process.

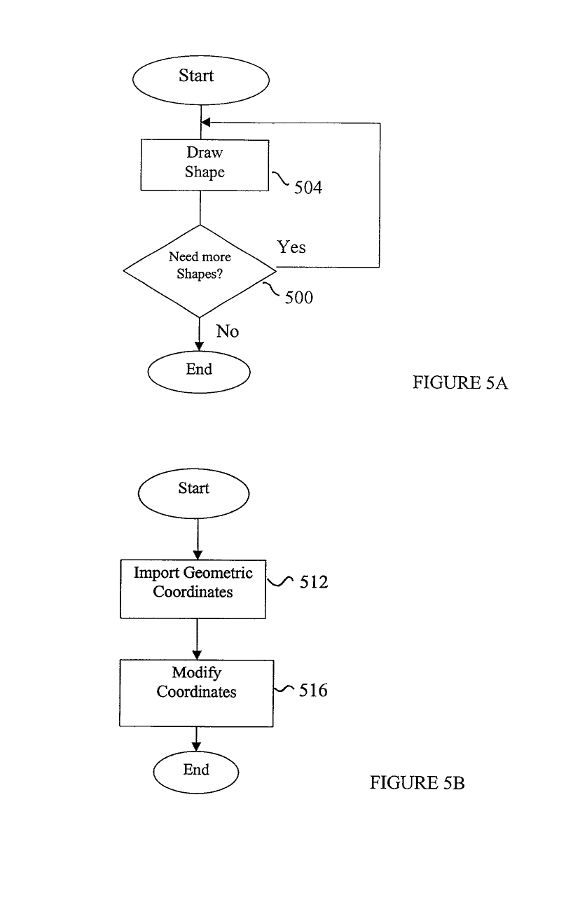

Referring to FIG. 4, the process of selecting an imaging experiment 304, 360 is now described in greater detail. First, one or images are selected 404. Next, a determination is made whether any refinement algorithms are desired 408. These refinement algorithms basically manipulate pixel data of an original image to obtain a modified image. Several examples include changing an intensity distribution of pixels in the image, or changing image properties such as, for instance, hue, saturation, contrast, brightness, tint, color, scale, morphing the image, or reducing image noise, and the like. If such algorithms are desired, they may be attached at 412 before continuing with a determination as to whether a geometrization algorithm is desired 416. If a geometrization algorithm is desired, a particular algorithm is selected 420, and subsequently attached 424. These geometrization algorithms basically establish a set of regions of interest on the image. Several examples of geometrization algorithms are described below with reference to FIGS. 5A and 5B and include manual or user-interactive specification of regions of interest, edge detection algorithms, or algorithms employing pixel intensity cut-off parameters. The particular geometry applied indicates a feature of interest with respect to the image at hand. Thus, using a weather satellite photograph as an example, a particular cloud shape, such as one possessed by a hurricane, could be the geometry of interest. In the context of microarrays, the geometry of interest could include many square or circular shapes, each of which is a region of interest corresponding to a specific spot on the image. Furthermore, it is entirely possible that several geometries may be needed on a single image. Referring back to the hurricane example, one geometry of interest may represent the eye of the hurricane while another geometry of interest may include the entire hurricane. Likewise, multiple images may share the same geometry.

Related to the issue of geometrization is the process of labeling. After each geometrization algorithm is attached to an image, a determination is made whether a labeling algorithm is desired 428. The labeling algorithm basically assigns labels to data obtained from the image, where the data may be associated with regions of interest. To illustrate using the microarray example, a label may be used to represent a particular gene name. Using the 2-D proteomics gel example, the labels may be used to identify different proteins. If a labeling algorithm is desired, one is selected 432. Determination of labels from a labeling algorithm may include traversing a geometry, in say a microarray, and automatically attaching a label for each of the gene names, according to the location of each region of interest. Alternatively, manual or user-interactive assignment of labels may be performed. Alternatively, labels may be retrieved or imported from an external map. In addition, each geometry may have multiple sets of labels. Subsequently, the selected labeling algorithm is attached to a geometry 436. Then, after attaching the labeling algorithm to a geometry 436 or if a labeling algorithm was not desired 428, determination is again made as to whether another geometrization algorithm is desired 416. If it is determined that a geometrization algorithm is desired 416, the above process is repeated. On the other hand, if it is determined, either initially or after one or more geometries have been applied, that a geometrization algorithm is not desired 416, processing continues with the selection of a quantitation algorithm 440. As mentioned above, the process of quantitation extracts data from the images for use in analysis. Thus, in the microarray example, a quantitation algorithm may be selected which identifies, for instance, the average intensity of all pixels that are 5% or 10% above background, or the standard deviation thereof. In the proteomics example, a quantitation algorithm may be selected which identifies the volume of each spot. Generically speaking, a quantitation algorithm basically calculates and reports summary statistics on pixel data of the image. In any event, whichever quantitation algorithm is selected, it is attached to an image at 444. The process of attaching quantitation algorithms continues, via loop 448, until each image has at least one quantitation algorithm attached thereto. Furthermore, any number of quantitation algorithms may be selected and attached. To attach additional quantitation algorithms, loop 452 is utilized.

In accordance with the principles of the present invention, subsequent to the processes of selecting and attaching quantitation algorithms, an envelope is specified for each of the parameters of each of the algorithms utilized, individually or in combination 456. For instance, in the microarray example, a geometrization algorithm that identifies spots on a chip may depend on a background intensity parameter or other quantities. The envelope may consist of specific quantities, a range of values, a probability distribution over a range of values, or other specification. Advantageously, by specifying an envelope of parameter values, the variability introduced by utilizing multiple analysis techniques can be considered in conjunction with the actual produced results, thereby providing a more accurate overall analysis.

Referring to FIGS. 5A and 5B, two geometrization algorithms are now described. In FIG. 5A, a manual geometrization algorithm is depicted. In this particular algorithm, any number of desired geometric shapes are drawn 504, with the process continuing until all of the desired shapes have been produced 508. As another example, in FIG. 5B, the geometries may be imported from an external file 512. After importation, any coordinates may then be modified 516.

As discussed above, after selecting an imaging experiment 304, 360, image analyses are performed at 308, 316, 364, 376 to produce the desired data. Performance of the image analyses 308, 316, 364, 376 is now described with reference to FIG. 6. As shown in FIG. 6, the image analyses 308, 316, 364, 376 commence with execution of any refinement algorithms 604, selected previously in, for example, steps 408 and 412. Subsequently, any geometrization, or labeling algorithms selected previously in, for instance, steps 420 and 432, are executed in steps 608 and 612, respectively. Next, the quantitation algorithm selected in step 440 is executed 616. Finally, upon completion of execution of the quantitation algorithm, data are produced for integration using any of the mathematical analyses described above.

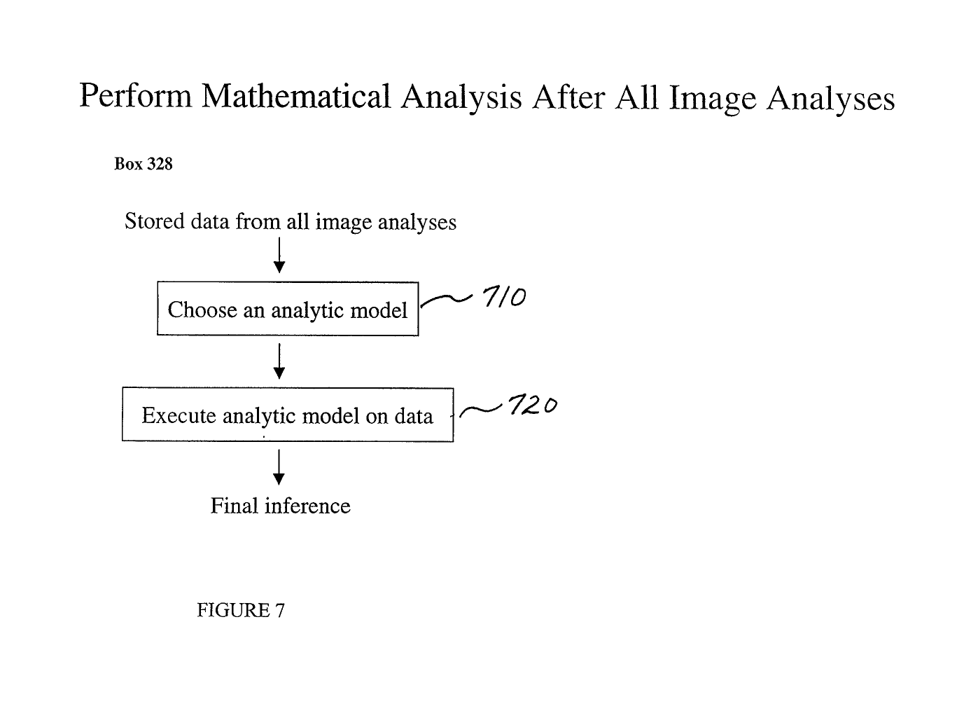

In accordance with the principles of the present invention, a mathematical or statistical analysis is performed at 308, which, as discussed above, combines the previously performed image analyses into a single process. Several examples of these mathematical or statistical analyses include analysis of variance (ANOVA), regression, latent class analysis or any other suitable statistical models. In particular, FIG. 7 depicts one example of the performance of a mathematical analysis 328 mentioned in FIG. 3A. First, the stored data from all of the previously performed image analyses are initially retrieved. Next, a specific analytical model is selected 710. Then, using the stored data from all of the image analyses, the selected analytical model is executed 720, resulting in a final inference comprising quantitative summaries of information derived from the data.

As another example, a mathematical analysis may be performed after the performance of each image analysis (FIG. 3B) with the mathematical analyses being combined to produce one or more inferences from the data. Referring first to FIG. 8, an example of the step of performing a first mathematical analysis 368 is described. In this regard, the stored data from the first image analysis is initially retrieved. Next, a specific analytical model is selected 810, followed by using the stored data as input during execution of the selected analytical model 820. As with the example of FIG. 7, execution of the analytical model 820 in FIG. 8 also results in an inference, in this case a first inference, comprising quantitative summaries of information derived from the data.

FIG. 9 depicts an example of the step of performing any additional mathematical analyses 380. As with the example in FIG. 8, data from the images are analyzed under the analytical model utilized in step 820. This results in the production of additional inferences which may or may not resemble any of the other inferences. Subsequently, as illustrated in FIG. 10, the first and additional inferences are combined in a step of computing meta-analytic summary 1010 to produce a final more precise inference.

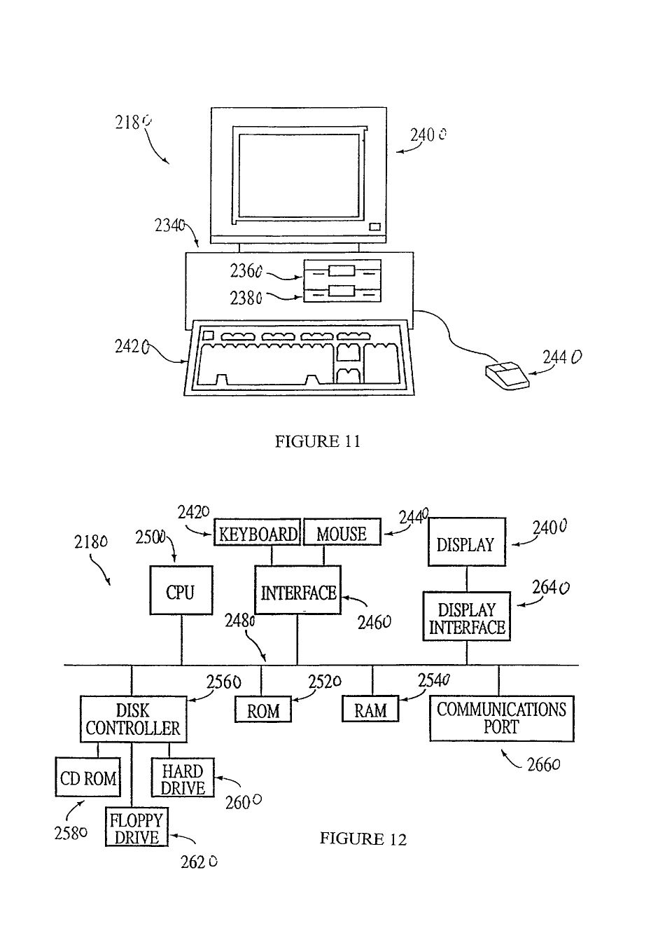

One example of a computing system utilizable for implementation of the processes of the present invention is depicted in FIG. 11. In this regard, FIG. 11 is an illustration of a main central processing unit capable of implementing some or all of the computer processing in accordance with a computer implemented embodiment of the present invention. The procedures described herein are presented in terms of program procedures executed on, for example, a computer or network of computers.

Viewed externally in FIG. 11, a computer system designated by reference numeral 2180 comprises a computer 2340, which may be for example, a Sun Sparc 3500 or the like running Windows NT, functioning as an Oracle server and a S-Plus computational engine at the backend. In addition, the processes of the present invention may just as easily be implemented on, for example, a network of Windows NT Pentium II and III single- or multiprocessor machines.

Disk drive indications 2360 and 2380 symbolically depict a number of disk drives which might be accommodated by the computer system. Typically, these would include a floppy disk or DVD drive 2360, a hard disk drive (not shown externally) and a CD ROM indicated by slot 2380, or the like. The number and type of drives vary, typically with different computer configurations. Disk drives 2360 and 2380 are in fact optional, and for space considerations, are easily omitted from the computer system used in conjunction with the production process/apparatus described herein.

In addition, a DVD writer (not shown) may be implemented to store any original images offline. Likewise, any thumbnail images may be stored directly in an Oracle or other database for access by user interfaces. Furthermore, AIT tape backups may also be utilized.

The computer system also has an optional display 2400 upon which information may be displayed. In some situations, a keyboard 2420 and a mouse 2440 are provided as input devices through which information or instructions may be inputted, thus allowing input to interface with the central processing unit 2340. Then again, for enhanced portability, the keyboard 2420 is either a limited function keyboard or omitted in its entirety. In addition, mouse 2440 optionally is a touch pad control device, or a track ball device, or even omitted in its entirety as well, and similarly may be used to input any information or instructions. In addition, the computer system also optionally includes at least one infrared transmitter and/or infrared received for either transmitting and/or receiving infrared signals, as described below.

FIG. 12 illustrates a block diagram of the internal hardware of the computer system 2180 of FIG. 11. A bus 2480 serves as the main information highway interconnecting the other components of the computer system 2180. CPU 2500 is the central processing unit of the system, performing calculations and logic operations required to execute a program. Read only memory (ROM) 2520 and random access memory (RAM) 2540 constitute the main memory of the computer. Disk controller 2560 interfaces one or more disk drives to the system bus 2480. These disk drives are, for example, floppy disk drives such as 2620, or CD ROM or DVD (digital video disks) drive such as 2580, or internal or external hard drives 2600. As indicated previously, these various disk drives and disk controllers are optional devices.

A display interface 2640 interfaces display 2400 and permits information from the bus 2480 to be displayed on the display 2400. Again as indicated, display 2400 is also an optional accessory. For example, display 2400 could be substituted or omitted. Communications with external devices, for example, the other components of the system described herein, occur utilizing communication port 2660. For example, optical fibers and/or electrical cables and/or conductors and/or optical communication (e.g. infrared, and the like) and/or wireless communication (e.g., radio frequency (RF), and the like) can be used as the transport medium between the external devices and communication port 2660. Peripheral interface 2460 interfaces the keyboard 2420 and the mouse 2440, permitting input data to be transmitted to the bus 2480. In addition to the standard components of the computer, the computer also optionally includes an infrared transmitter and/or infrared receiver. Infrared transmitters are optionally utilized when the computer system is used in conjunction with one or more of the processing components/ stations that transmits/receives data via infrared signal transmission. Instead of utilizing an infrared transmitter or infrared receiver, the computer system optionally uses a low power radio transmitter and/or a low power radio receiver. The low power radio transmitter transmits the signal for reception by components of the production process, and receives signals from the components via the low power radio receiver. The low power radio transmitter and/or receiver are standard devices in industry.

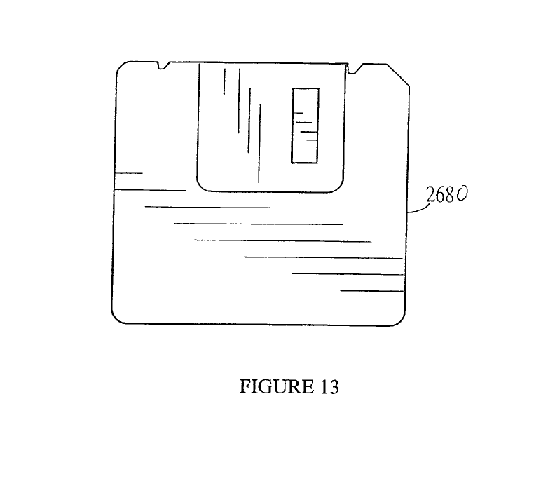

FIG. 13 is an illustration of an exemplary memory medium 2680 which can be used with disk drives illustrated in FIGS. 11 and 12. Typically, memory media such as floppy disks, or a CD ROM, or a digital video disk will contain, for example, a multi-byte locale for a single byte language and the program information for controlling the computer to enable the computer to perform the functions described herein. Alternatively, ROM 2520 and/or RAM 2540 illustrated in FIGS. 11 and 12 can also be used to store the program information that is used to instruct the central processing unit 2500 to perform the operations associated with the production process.

Although computer system 2180 is illustrated having a single processor, a single hard disk drive and a single local memory, the system 2180 is optionally suitably equipped with any multitude or combination of processors or storage devices. Computer system 2180 is, in point of fact, able to be replaced by, or combined with, any suitable processing system operative in accordance with the principles of the present invention, including sophisticated calculators, and hand-held, laptop/notebook, mini, mainframe and super computers, as well as processing system network combinations of the same.

Conventional processing system architecture is more fully discussed in Computer Organization and Architecture, by William Stallings, MacMillan Publishing Co. (3rd ed. 1993); conventional processing system network design is more fully discussed in Data Network Design, by Darren L. Spohn, McGraw-Hill, Inc. (1993), and conventional data communications are more fully discussed in Data Communications Principles, by R. D. Gitlin, J. F. Hayes and S. B. Weinstain, Plenum Press (1992) and in The Irwin Handbook of Telecommunications, by James Harry Green, Irwin Professional Publishing (2nd ed. 1992). Each of the foregoing publications is incorporated herein by reference. Alternatively, the hardware configuration is, for example, arranged according to the multiple instruction multiple data (MIMD) multiprocessor format for additional computing efficiency. The details of this form of computer architecture are disclosed in greater detail in, for example, U.S. Pat. No. 5,163,131; Boxer, A., Where Buses Cannot Go, IEEE Spectrum, February 1995, pp. 41-45; and Barroso, L. A. et al., RPM: A Rapid Prototyping Engine for Multiprocessor Systems, IEEE Computer February 1995, pp. 26-34, all of which are incorporated herein by reference.

In alternate preferred embodiments, the above-identified processor, and, in particular, CPU 2500, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) or the like.

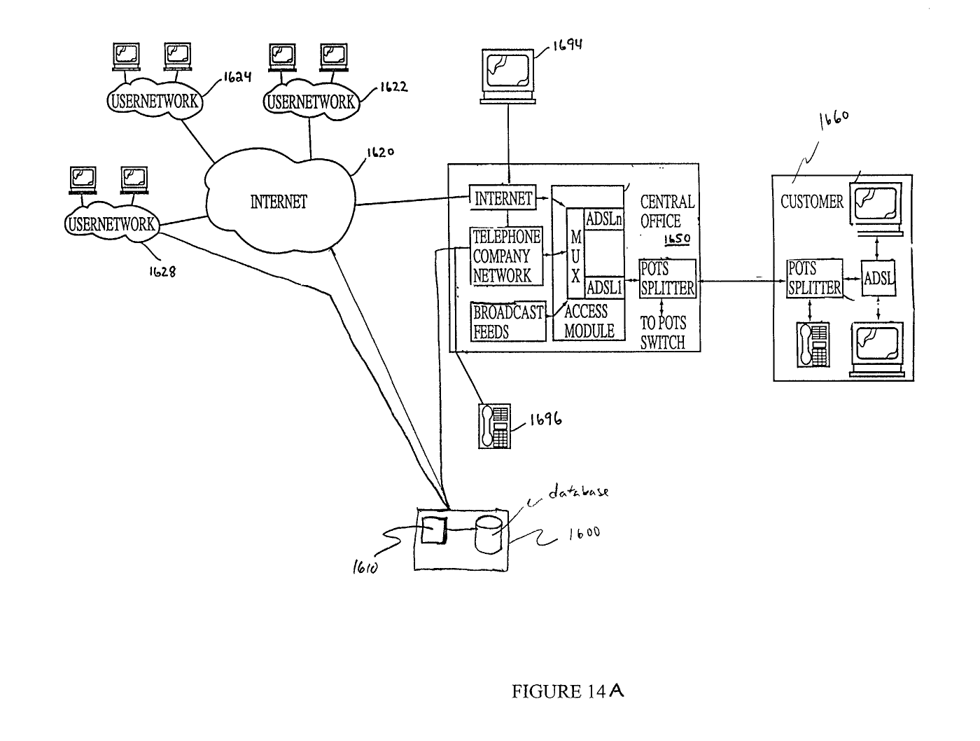

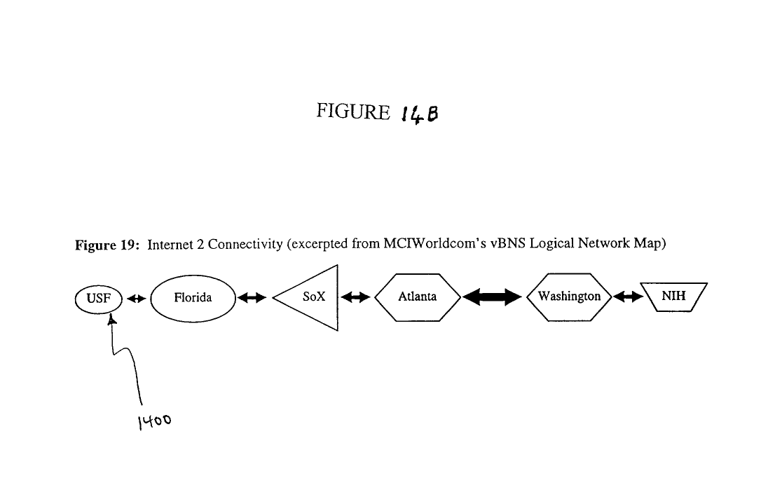

FIG. 14 is an illustration of the architecture of a combined Internet, POTS (plain, old, telephone service), and ADSL (asymmetric, digital, subscriber line) system for use in accordance with the principles of the present invention. Furthermore, it is to be understood that the use of the Internet, ADSL, and POTS are for exemplary reasons only and that any suitable communications networks and protocols may be substituted without departing from the principles of the present invention. This particular example is briefly discussed below.

In accordance with the principles of the present invention, in FIG. 14, a main server 1600 implementing the process 1610 of the invention may be located on one computing node or terminal. Then, various remotely located users may interface with the main server via, for instance, the ADSL equipment discussed below, and utilize the processes of the present invention from remotely located PCs. For example, in FIG. 14, ADSL equipment 1650 provides access to a number of destinations including significantly the Internet 1620, and other destinations 1670, 1672 to customer 1660. Similarly, cable television providers (not shown) provide analogous Internet service to PC users over their TV cable systems by means of special cable modems. Such modems are capable of transmitting up to 30 Mb/s over hybrid fiber/coax system, which use fiber to bring signals to a neighborhood and coax to distribute it to individual subscribers.

Cable modems come in many forms. Most create a downstream data stream out of one of the 6-MHz TV channels that occupy spectrum above 50 MHz (and more likely 550 MHz) and carve an upstream channel out of the 5-50-MHz band, which is currently unused. Using 64-state quadrature amplitude modulation (64 QAM), a downstream channel can realistically transmit about 30 Mb/s (the oft-quoted lower speed of 10 Mb/s refers to PC rates associated with Ethernet connections). Upstream rates differ considerably from vendor to vendor, but good hybrid fiber/coax systems can deliver upstream speeds of a few megabits per second. Thus, like ADSL, cable modems transmit much more information downstream than upstream. Then Internet architecture 1620 and ADSL architecture 1650 may also be combined with, for example, user networks 1622, 1624, and 1628.

Thus, in the example depicted in FIG. 14, a user located on Network 1622, 1624, 1628 or nodes 1694, 1696 or 1660 may access server 1600 implementing the present invention via the Internet 1620, or via another similar communications network.

Similarly, the present invention may include, for example, a Java Web-based interface for biologists and others to access its models. For example, the present invention may include an interface to the Internet 2 wide-area research network. Referring to FIG. 14B the system of the present invention 1400 may be connected to the NIH and other Internet 2 institutions through, for example, a maximum 45 Mbps digital network. FIG. 14B illustrates an Internet 2 connection to the NIH which facilitates provision of the systems resources to molecular biologists around the world.

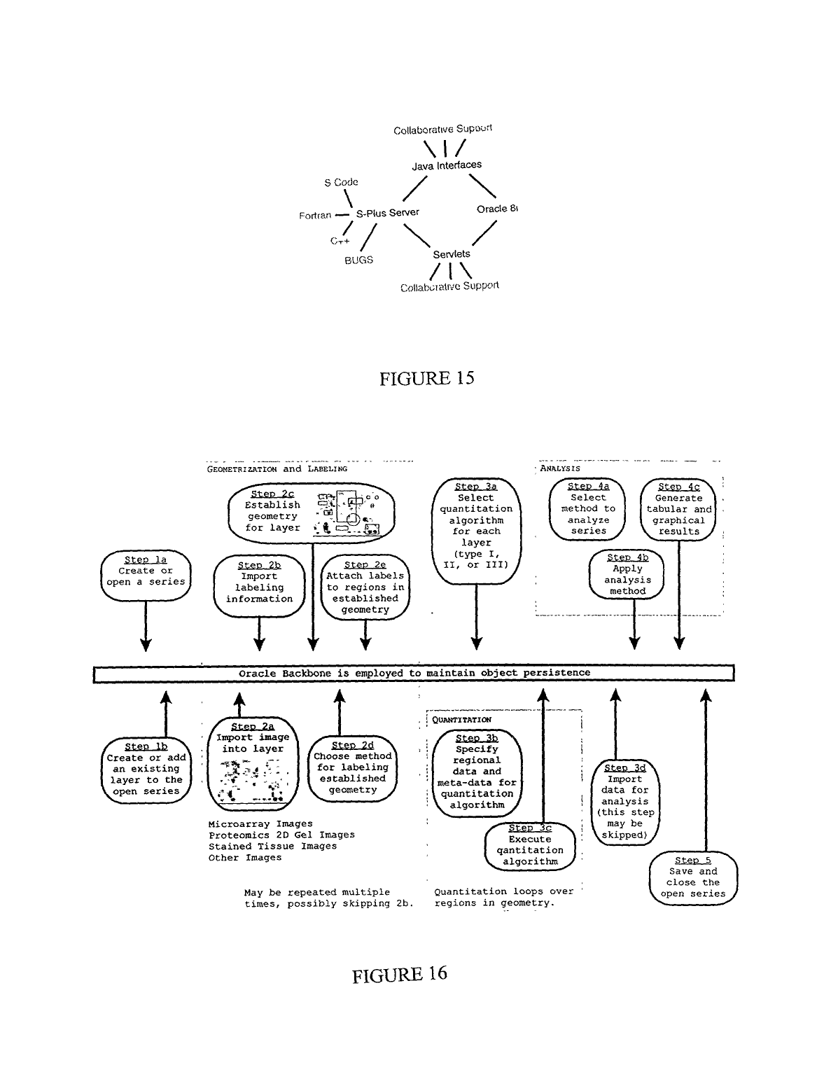

Referring to FIG. 15, one embodiment of the present invention utilizes, for example, multiple Java interfaces and servlets built from reusable object-oriented code to tie together powerful statistical and database systems. Specifically, an Oracle or other similar platform performs substantially all storage and data management. Oracle8i, for example, is utilized to take advantage of certain features including Java integration, extensibility and scalability, and support for multimedia data types which allow for efficient integration of imaging and metadata information. Integrated support for Java technology in the Oracle8i database system allows the system of the present invention to leverage Java technology across its entire design —from the back-end database through application middle tiers (such as servlets) to the enduser desktop. In addition, Oracle8i's extensibility features extend the native capabilities of the database in a truly seamless fashion, to enhance the database with the technologies developed by the present invention. This is accomplished, for instance, using Oracle JDBC drivers and the associated Java API that provides cross-DBMS connectivity to a wide range of SQL databases as well as access to other tabular data sources, such as spreadsheets and flat files. This particular embodiment extends the GATC schema, to store images and data derived from a variety of molecular biology experimental contexts, such as proteomics and microscopy. Multiple interfaces drawing on the common database environment allow for data entry.

S-Plus is provided as one example of a statistical engine utilized by this particular embodiment. The use of S-Plus in the present invention allows integration with other software. For inclusion of novel statistical methods, S-Plus employs an open environment model that allows users to incorporate their own compiled code into the system. For example, novel mathematical algorithms can be added by dynamically loading C++ or Fortran routines. In addition, the S-Plus server system can accept requests from Java programs for statistical computations.

The use of Java allows the present invention to maintain cross-platform independence, to integrate tools existing in multiple otherwise unrelated applications, and to easily deploy a client-server multi-threaded model system. For example, Java 2 may be used as the basis for the system's code, supplemented by the Java Advanced Imaging (JAI) Application Programming Interface (API). In addition, the Java Development Kit (JDK) may be implemented to incorporate Swing components (which are used for windowing functions) and the 2D API. The Java Database Connectivity (JDBC) API allows developers to take advantage of the Java platform's capabilities for industrial strength, cross-platform applications that require access to enterprise data. The JAI API is the extensible, network-aware programming interface for creating advanced image processing applications and applets in the Java programming language. It offers a rich set of image processing features such as tiling, deferred execution and multiprocessor scalability. Fully compatible with the Java 2D API, developers can easily extend the image processing capabilities and performance of standard Java 2D applications.

FIG. 16 illustrates another representation of the system of the present invention, focusing on the Oracle backbone, which is used for object persistence. First a series of image-dependent or imageless layers, upon which analysis will be performed, are loaded into the system (Step 1). Memory is carefully managed at this step and throughout the process, since it is impossible to expect either client or server to simultaneously manage, say, 40 microarray images, each of which is upwards of 40 Mb long. A rendered composite image, if available, is displayed on the client according to user-adjustable preferences. Imageless layers are allowed so that analysis may be performed even when the associated images are not available. When images are available, one or more geometries for each layer are established (Step 2). As discussed above, a geometry includes a set of closed, possibly-overlapping regions-of-interest (or shapes), each of which is not exclusively contained in any other. Geometry may be established by hand through a sketchpad interface, or by application of a geometrization algorithm (see, e.g., FIGS. 5A and 5B). The use of geometrization algorithms allows modeling, in a single system, images with formats that are largely fixed by the investigator, as for example result from microarray studies, images with semi-fixed geometries as from proteomics studies, and images with free-form geometries as from cell or tissue microscopy. Labels are then attached by reference to one or more labeling algorithms (end of Step 2). These may be relatively simple—typically, microarray labels are established by considering the spot centers—or fairly complex—protein labels on 2-D gels are established by considering the overall geometry and relative positions of shapes in that geometry. Geometries are calculated and labels established using server-side Java or C++ code, with rendered results posted to the client. Next, quantitation occurs (Step 3) by referencing one or more quantitation algorithms, which execute looping over shapes in the geometry. Quantitation may result in all kinds of information including: (1) primary signal information, such as average or median intensity of the pixels in regions-of-interest; (2) signal variability information, such as pixel variance, kurtosis, or direction of one or more principal components; (3) signal location information, such as coordinates of the intensity mode within a region-of-interest; and (4) cross-image signal comparison information, such as pixel correlation between two images (used for quality control). Advantageously, the system allows for substantial extensibility in the application of geometrization, labeling and quantitation algorithms. Depending on the algorithm, quantitation may be performed by, for example, server-side Java or C++ code, or by the S-Plus Server system. Note that geometrization algorithms may also be employed within the quantitation step, without requiring persistent storage of the resulting geometry, as might be needed when one wishes to compare quantitative performance of two spotfinding algorithms within regions-of-interest in a specified geometry. External data, for which no images are available, are also retrieved at this time. Analysis of the quantitation results occurs in Step 4. Methods which may be employed include simple regressions, ANOVA and principal components analyses by referring to the methods built into the S-Plus analytic engine. Novel mathematical models are included by incorporating C++ or Fortran compiled code into the S-Plus engine, or by direct reference to external code on the server. Graphical, tabular or data-formatted results can be exported for reports or stored on the Oracle backbone for later use (Step 5).

This integrated system for imaging and mathematical modeling work results in technology allowing for easy conduct of joint imaging and analysis experiments. As an example, consider an experiment using 40 microarray slides that were assembled on two different days. Of particular concern is that the data analysis might be sensitive to problems suspected with the microarrayer pins. Three combined sets of geometrization, labeling and quantitation algorithms that can be applied to these data have been developed, each of which has some benefits and some drawbacks in terms of ability to adjust the resulting data for experimental difficulties. Each algorithm additionally has some imaging parameters that can be specified by the user, such as background pixel intensity cutoffs, complexity-cost, scale or tolerance parameters. Suppose there are 5 such parameters in each algorithmic set, each having a low, medium or high value in a reasonable range. According to the techniques of the present invention, the microarray slide images may be analyzed using each of the algorithm sets and a range of parameters to obtain, say, an analysis based on each of 3×3×5 =45 combinations of imaging methods. These analyses could then be averaged and deviant analytic results investigated using system statistical meta-analysis techniques. For example, Bayesian statistical methods may be employed to average-out the effect of imaging-related variability from the analysis, thereby obtaining a composite estimate that does not rely on a specific imaging protocol.

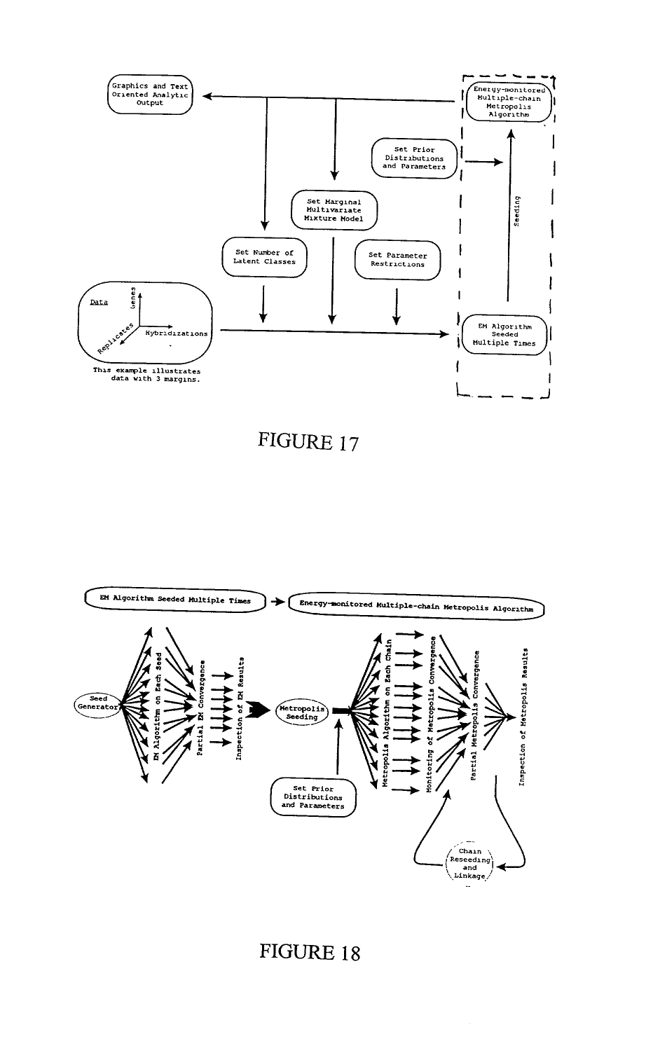

Referring to FIG. 17, one example of a mathematical model is presented. FIG. 17 depicts a latent class analysis, which identifies quantitative fingerprints of cellular characteristics and processes. This example employs two-dimensional, generalized, latent class structures in a Bayesian statistical framework to identify and describe patterns among genes (first dimension) and microarray hybridizations (second dimension). Further description of this latent class analysis is made in U.S. Provisional Patent Application Ser. No. 60/180,282, filed Feb. 4, 2000, and U.S. Provisional Patent Application Ser. No. 60/204,773, filed May 17, 2000, both to Dr. Emmanuel Lazaridis, which are incorporated herein by reference including all of the references cited therein.

In the case of Bayesian statistical models, the algorithms calculate the joint estimates of each parameter in the model using a variation of the Metropolis algorithm, along with their full posterior distributions. These results are available for post-processing to develop graphical and textual representations which are then reported to the analyst. The system works as indicated in FIG. 17. Specifically, data derived by the above imaging methods first enter the sampling environment. A model and its properties and parameters are established by an analyst. A series of frequentist and Bayesian estimation procedures, including EM and Metropolis algorithms, are then available for estimation of model parameters. The user-controlled sampling process in the dashed box in FIG. 17 is shown in expanded form in FIG. 18. The essence of this approach is to seed and evaluate each stage of the algorithm multiple times. The performance of each chain is monitored individually and as a group in real-time. As sampling progresses, the analyst clamps down on the sampler according to the consistencies observed in convergence across the chains, thereby simplifying the algorithmic work for future updates. The analyst may also decide to loosen restrictions on the chains in order to broaden the sampling space.

### 7. EXAMPLES

Advantageously, the processes of the present invention find use in a wide variety of applications. For example, in the context of microarrays, early detection and evaluation of potential tumors will be possible in the future by comparing their gene expression profiles with an established profile characteristic of specific tumor types. Signal Transducers and Activators of Transcription (STATs) are transcription factors that regulate gene expression in response to cytokine and growth factor stimulation. Recently, it was recognized that one member of the STAT family, STAT3, is frequently activated in many diverse human tumors, and that the STAT3 protein has an essential role in oncogenesis. See, Garcia R, Jove R: Activation of STAT transcription factors in oncogenic tyrosine kinase signaling. J. Biomed. Sci. 1998, 5: 79-85; Garcia R, Yu CL, Hudnall A, Catlett R, Nelson K L, Smithgall T, Fujita D J, Ethier S P, Jove R: Constitutive activation of Stat3 in fibroblasts transformed by diverse oncoproteins and in breast carcinoma cells. Cell Growth. Diff 1997, 8: 1267-76; and Catlett-Falcone R, Landowski T H, Oshiro M M, Turkson J, Levitzki A, Savino R, Ciliberto G, Moscinski L, Femandez-Luna J L, Nuñez G, Dalton W S, Jove R: Constitutive activation of Stat3 signaling confers resistance to apoptosis in human U266 myeloma cells. Immunity 1999, 10: 105-15, each of which is incorporated herein by reference. Accumulating evidence indicates that activation of the STAT3 transcription factor is involved in both initiation and maintenance of neoplastic transformation. See, Yu CL, Meyer D J, Campbell G S, Larner A C, Carter-Su C, Schwartz J, Jove R: Enhanced DNA-binding activity of a Stat3-related protein in cells transformed by the Src oncoprotein. Science 1995, 269: 81-3; and Turkson J, Bowman T, Garcia R, Caldenhoven E, De Groot R P, Jove R: Stat3 activation by Src induces specific gene regulation and is required for cell transformation. Mol. Cell. Biol. 1998, 18: 2545-52, each of which is incorporated herein by reference. Furthermore, it is believed that STAT3 activation contributes to malignant progression by regulating gene expression that protects tumor cells from programmed cell death, suggesting that tumors with activated STAT3 may be resistant to chemotherapy and radiation therapy. See, Bromberg J F, Wrzeszcynska M H, Devgan G, Zhao Y, Pestell R G, Albanese C, Darnell J E: Stat3 as an oncogene. Cell 1999, 98: 295-03, which is incorporated herein by reference. Based on these findings, it appears that the increase in STAT3 activity levels seen in many types of human cancers results in an alteration of the cell's gene expression profile that is characteristic of tumors harboring activated STAT3. The characteristic pattern of STAT3-dependent gene expression associated with oncogenesis, being derived from statistical models of experimental data, is then termed the STAT3 molecular fingerprint.

Accordingly, such a STAT3 molecular fingerprint may be of assistance in the screening and evaluation of patient tumor specimens. Consequently, the goal of this particular example is to define the STAT3-specific gene expression profile in human cancers with activated STAT3. Using microarray technology, gene expression data on model human tumor cell lines derived from breast carcinomas is collected. To identify the STAT3-dependent gene expression patterns, the levels of STAT3 activity with growth factors and cytokines known to induce STAT3 activation in these tumor cell lines are increased. Conversely, STAT3 activity is blocked in these cells using specific pharmacologic inhibitors of tyrosine kinases that activate STAT3 signaling. As a complementary approach, dominant-negative and constitutively-activated forms of STAT3 protein are introduced into the cell lines. By comparing the gene expression patterns of thousands of genes under these different experimental conditions, the STAT3 molecular fingerprint in the model cell lines may be defined. The STAT3-specific gene expression patterns are further refined and verified using primary tumor specimens from patients with breast cancer. Using, for example, the latent class analysis method described above, a characteristic STAT3 molecular fingerprint common to human tumor cells having elevated levels of STAT3 activation may be defined. Comparison of the gene expression profile obtained from a patient tissue sample to an established STAT3 molecular fingerprint will identify cancer presence as well as provide additional information on tumor stage, metastatic potential, and likely response to chemotherapy and radiation therapy.

Accordingly, it is clear that this example depends on carefully integrated execution of imaging and statistics methods. Thoroughly investigating and understanding how factors involved in the process of quantitation affect the results of statistical analyses is extremely important in the context of this example.

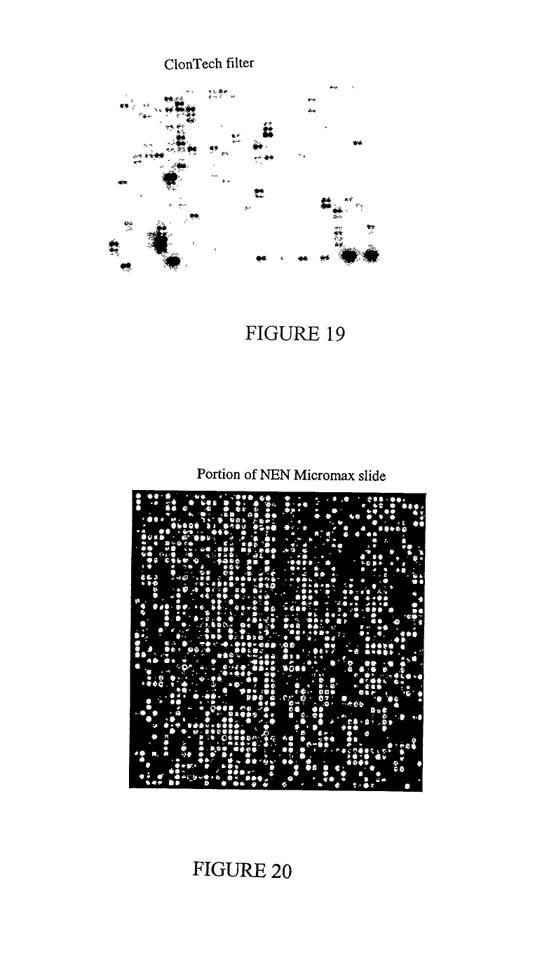

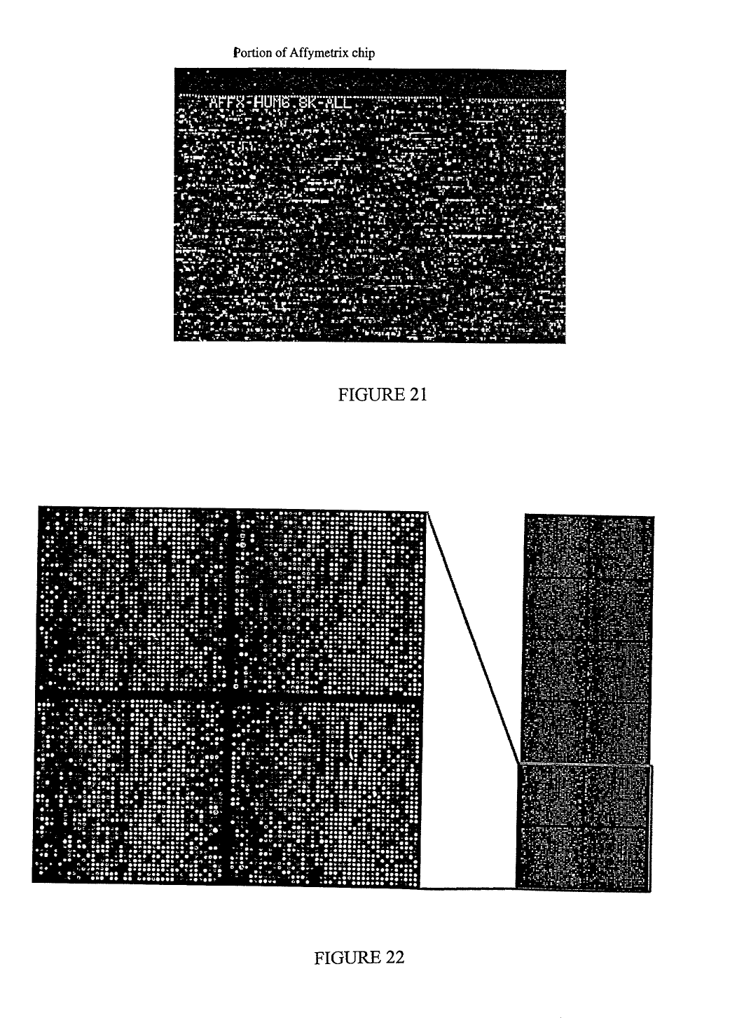

Three kinds of microarray technology are used in conjunction with this example: ClonTech filters (FIG. 19), NEN Micromax glass slide technology (FIG. 20), and the Affymetrix GeneChip system (FIG. 21). Prefabricated microarray filters from ClonTech were used to analyze mRNA expression levels for 589 cDNAs at a time, for experimental samples and concurrent controls. Once RNA is isolated, reverse transcriptase is used to create ³²P-radiolabeled cDNA, which is then hybridized to the cDNA on the filter. Following a high stringency wash, the filter is imaged using a phosphorimager. Normalized spot intensities quantify the relative expression of mRNAs between control and experimental samples. NEN Micromax glass slide technology, in which 2400 cDNAs representing known human genes are arrayed on a slide, was used. Total RNA was isolated from the cells, reverse transcribed to generate tagged cDNA, and gene expression was detected using special dyes in combination with a dedicated laser scanning instrument.

FIG. 20 shows the laser-scanned image of an NEN Micromax glass slide after hybridization of a specific sample. As an example, the Affymetrix GeneChip system, which uses photolithography in conjunction with light activated chemistry to synthesize on chips sets of oligonucleotides representing different segments of a given gene may be employed. The Hu6800 array (FIG. 21) uses approximately 20 such oligonucleotides for each of the 6800 unique genes contained on the chip. The RNA of interest is isolated. Reverse transcriptase is used to create cDNA, and an in vitro transcription reaction is used to create Biotin labeled RNA. The labeled RNA is hybridized to the array overnight, followed by a high stringency wash. A Streptravidin-phycoerythrin conjugate is used to bind to the labeled cDNA. The intensity of each oligonucleotide is determined by laser scanning, and assignment of an intensity level for each gene requires application of a mathematical model. Of particular importance in this example is the fact that estimates of gene expression from the Affymetrix system depend not only on the imaging procedures applied to the chips, but also on the quantitation model that combines the oligonucleotide measurements into summary statistics to represent the genes. Thus, the present invention may be utilized to determine what effect this additional complexity has on quantitative analysis.

In a second microarray example, a microarrayer based on the construction of ultrahigh density cDNA microarrays on glass microscope slides followed by hybridization with fluorescently labeled cDNA and analysis using a confocal laser scanner was developed (see, e.g., FIG. 22). FIG. 22, depicts the hybridization of Cy3 and Cy 5 labeled probes to a region of a 19,200-element human array from TIGR. A Cy3-labeled probe from the KM12C colon tumor cell line and a Cy5-labeled probe from the KM12L4a were prepared and competitively hybridized to the array. The cDNA from one tumor source is labeled with a red fluorescing compound while the cDNA from a second tumor source is labeled with a green fluorescing compound. The resultant hybridization results in a red:green fluorescent ratio representing the degree of hybridization (and gene expression) of one sample versus another. Microarrays allow the simultaneous interrogation of thousands of cDNA clones with RNA from the tissue or developmental stage of interest, using fluorescently labeled probes and confocal laser microscopy to quantify the relative expression levels of many genes in a single experiment by comparing different tissues. Using this and proteomics technology, the molecular characteristics which allow identification of persons at higher risk of metastasis among individuals with colorectal cancer may be identified.

Advantageously, the present invention ensures the quality of the data obtained by assessing the impact of two known confounding factors (tissue ischemia and normal cell contamination), and by identifying the genes most commonly affected by these factors. Furthermore, the present invention rigorously assesses the reproducibility of the methodologies and the need for repetitions. High quality tissues are selected, distinguished by their biological potential for metastasis but without regard to standard tumor staging criteria, so as not to bias the subsequent analyses. Patterns of gene expression portending metastasis are then identified by microarray analysis and compared with those identified by proteomic analysis to determine if the methods are confirmatory and/or complementary. Because it is assumed that patterns of gene expression portending metastasis may be difficult to decipher, based on the complex biology of the process and on the multiple classes of molecules presumed to play a role, the present invention may be used to further refine the patterns by employing microarrays on human colon cancer cell line metastatic variants and on experimentally induced mutant P53 expressing human colon cancer cell lines.

As with the microarray studies of the above STATs example, this example depends on carefully integrated execution of imaging and statistics methods. Thoroughly investigating and understanding how factors involved in the process of quantitation affect the results of statistical analyses is extremely important to its success. The sensitivity of four statistical methods in particular to changes in imaging parameters are advantageously addressed using the analytic environment of the present invention (i.e., latent class methods, gene shaving techniques, ratio models, and hierarchical clustering).

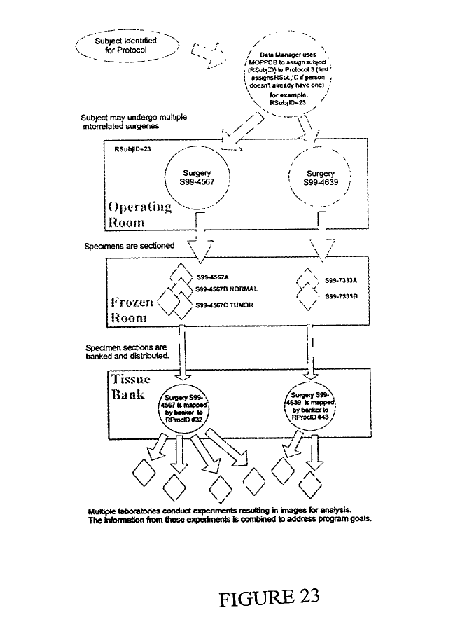

Another example in the context of microscopy is depicted in FIG. 23. In this example, the present invention is utilized to integrate two or more applications or resources. One of the applications, generically referred to herein as the MOPP or MOPPDB database, lacks the capability to analyze images. FIG. 23 illustrates how the MOPP database integrates molecular biology findings among various laboratories by demonstrating how specimens are tracked. Each participating laboratory generates one or more images which, at the present time, are quantified prior to database entry.

In this example, the MOPPDB database drives an application implemented as an Oracle backend (tables and stored procedures), a Visual Basic middle tier, and a Web front-end (Active Server Pages using VBscript, Javascript, and Active Data Objects). It provides the ability to manage the clinical and research data being collected and analyzed for a set of protocols that comprise this large bench-to-bedside translational project. MOPPDB has two faces: the clinical side is used to register patients as research subjects, assign patients to one or more protocols, enter and edit clinical research data that supplements existing data from institutional clinical information systems, and interface with our computerized patient record system; the research laboratory side is used by a variety of research laboratories for constrained entry and edit of assay results related to MOPP protocols, and interface with a second application, generically referred to herein as the Research Specimen Tracking (RST) system.

The RST is a protocol-driven database application that tracks receipt of solid or liquid tumor (or normal control) specimens for research purposes. Research specimens are received by a ‘banker’, who records in RST: receipt of the specimen from a clinical (surgery, bone marrow extraction, etc.) or research procedure; banking of the specimen for later research; and distribution of the specimen or a portion thereof for specific experiments. In this example, the system is implemented as a Web Frontend (HTML, DHTML, and Active Server Pages with VBScript, Javascript, and ADO) and Oracle Backend with Visual Basic Middle Tier. Furthermore, it may be modeled using Rational Rose and Unified Modeling Language (UML) and implemented using an object-oriented approach.

By integrating with these two applications, the present invention enhances each with image-related database and analytic capabilities. For example, it is well known that for many solid tumors, sections are not homogeneous in terms of their cellular components. Some tumors may have a greater proportion of cancer cells in one section than in another, or different kinds of normal tissues infiltrating the sample. For each particular protein, one must determine the optimum method of quantifying staining (including cytoplasmic or plasma membrane staining) by computer-assisted image analysis with appropriate standard reference cell lines and negative controls. In addition, matched sets of non-tumor and tumor tissues are compared for each patient. Not only can these inhomogeneities affect quantitation across samples, but it is likely that differences in the imaging properties of different immunohistochemical or immunocytochemical markers will also lead to differential staining, possibly confounding with the science of interest. Advantageously, integration of the MOPP image analysis protocols with the process of the present invention substantially improves the ability to explore these very complicated interactions.

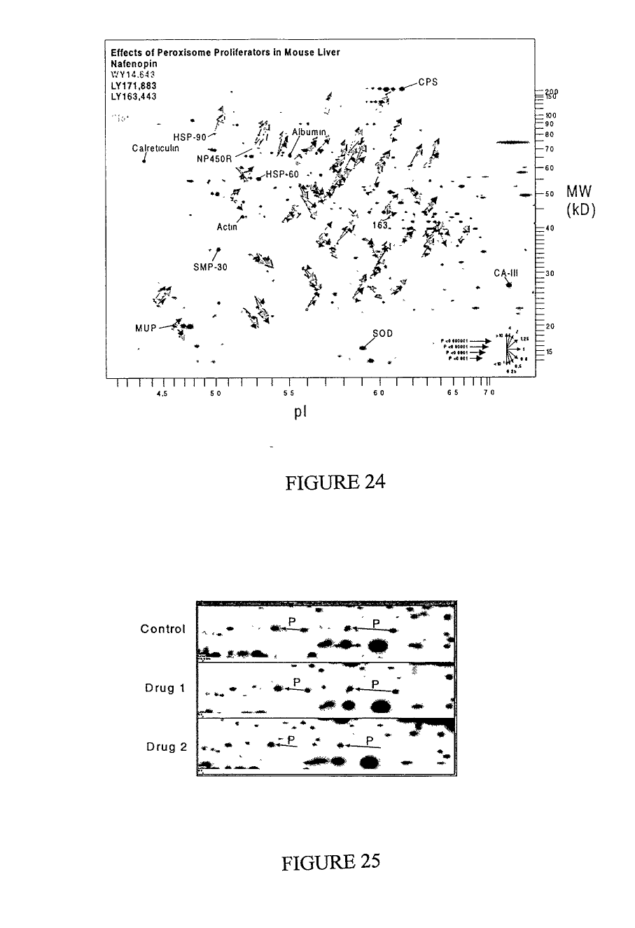

A final example in the context of quantitation and analysis of proteomics 2-D gels is now described with reference to FIGS. 24-25. Proteomics analysis is performed by combining 2D-gel electrophoresis, to separate and quantify protein levels, with two forms of mass spectroscopy to identify selected proteins of interest within the 2D gel. This is the highest resolution analytical procedure for routine global analysis of proteins currently available, and it is possible to do large-scale quantitative protein mapping studies. As with other comprehensive experimental approaches, a major limitation to the application of proteomics 2D-gel technology has been in the ability to derive information from the resulting images. As mentioned previously, although some software for the analysis of these images exists, it is uniformly unsophisticated, depending in large part on non-statistical algorithms and user interaction to quantitate an image. Analysis of the resulting data is also divorced from the quantitation procedures, which may have a substantial effect on what conclusions may be drawn.

Application of the present invention to this example is based on a sophisticated statistical technology called Bayesian morphology, that can overcome current analytic limitations. This statistical technique is used to address problems of spot detection and quantification, in the context of experiments requiring comparison across multiple 2-D gels, and to compare these techniques with current standards in 2-D gel analysis software.

The techniques of the present invention, in the context of this example, are utilized to study farnesyltransferase inhibitors (FTIs). See, Sebti S M, Hamilton A D: Inhibition of Ras prenylation: A novel approach to cancer chemotherapy. Pharm. Therapeutics 1997, 74: 103-114; and Gibbs J B, Oliff A: The potential of farnesyltransferase inhibitors as cancer chemotherapeutics. Annu. Rev. Pharmacol. Toxicol. 1997, 37: 143-166, each of which is incorporated herein by reference. These are effective anticancer agents in animal models. Because they have been observed to lack toxicity to normal cells, it is thought that there may be a farnesylated protein or a set of farnesylated proteins that play a pivotal role in malignant transformation but not in normal cell physiology. Ras, a small GTPase, is a good candidate since it is farnesylated and has been implicated in about 30% of all human cancers. See, Barbacid M: Ras genes. Ann. Rev. Biochem. 1987, 56: 779-828; Barbacid M: Human oncogenes. In Important advances in oncology, Eds. Devita, Hellman and Rosenberg. Philadelphia: Lippincott, 1986, 3-22, each of which is incorporated herein by reference. However, Ras cannot be the only candidate since the oncogenic Ras mutation status does not correlate with the sensitivity of human tumors to FTIs. See, Sepp-Lorenzino L, Ma Z, Rands E, Kohl N E, Gibbs J B, Oliff A, Rosen N: A peptidomimetic inhibitor of farnesyl:protein transferase blocks the anchorage-dependent and -independent growth of human tumor cell lines. Cancer Res. 1995, 55: 5302-5309. Therefore it stands to reason that farnesylated proteins in addition to Ras must be involved in the tumorigenesis process and that inhibition of their farnesylation blocks malignant transformation. Thus, the present invention in conjunction with the proteomics technology may be used to identify farnesylated proteins critical to lung tumorigenesis. In particular, three sets of proteomics experiments are conducted: (1) to seek differences in expression levels of farnesylated proteins in mouse lungs at various times after carcinogen treatment, seeking farnesylated proteins critical to NNK-induced lung tumorigenesis; (2) to determine and compare the effects of FTIs on the expression, activity and farnesylation levels of farnesylated proteins in lungs from FTI vs. vehicle treated mice; and (3) to evaluate the effects of FTI treatment on the farnesylation and expression of farnesylated proteins to determine the differences in their expression levels in a panel of human tumors that are either resistant or sensitive to FTIs. Analyzed together using the present analytic techniques, a set of farnesylated proteins that will have chemopreventive as well as chemotherapeutic value may be identified.

In addition, the same colon cancer samples in the associated microarray project described above may also be analyzed. Databases are employed to construct master gels for use in the identification of proteins from unknown tumor specimens through gel matching techniques. Analysis of complex quantitative differences among a series of protein expression patterns proceeds in the following manner. Proteins are extracted from a series of samples under different conditions. Each sample is run on a 2-D gel, which is then imaged. Subsequently, proteins spots are matched across the gels, and abundance ratios (say, of treated or diseased relative to normal control values) are calculated. Subsequently, proteins are selected for sequencing according to how they differ across experimental conditions. Such results are plotted, and multiple comparisons examined for consistency using different colors (see, e.g., FIG. 24). In FIG. 24, a series of drugs known to be non-genotoxic liver carcinogens in the mouse, have been compared and found to produce consistent effects on the abundances of a large series of identified liver proteins, with concordant increases or decreases. These sorts of analyses can be exploited to examine molecular fingerprints that are shared between a primary tumor and its paired metastasis. Because proteomic analyses are capable of examining serum proteins, it is feasible to conduct differential analysis of patient-derived serum samples, to look for secreted proteins linked to the process of metastasis.

This example involves a two-dimensional mathematical filter that removes background, deconvolves each protein spot into one or more Gaussian peaks, and calculates the volumes under each peak (representing protein quantity). A multiple montage program allows the comparable areas of a series of up to 1,000 gels to be displayed and inter-compared visually to check on pattern matching. In matching individual gels to the chosen master 2-D pattern, a series of about 50 proteins is matched by an experienced operator working with a montage of all the 2-D patterns in the experiment. Subsequently, an automatic program is used to match additional 600-1000 spots to the master pattern using as a basis the manual landmark data entered by the operator.

Because a 2D-GE analysis of an individual tumor results in a protein molecular fingerprint which can be directly compared to that of numerous other tumors, differentially expressed proteins are rapidly identified. Moreover, with the elucidation of several critical signal transduction pathways, such as the Ras pathway, it is clear that not only gene expression, but also phosphorylation of gene products, is central to the regulation of the cell and a critical part of the comprehensive analysis of gene expression. Because phosphorylated and unphosphorylated versions of a protein occur at different locations on a 2-D gel, differential quantitation of the forms can be assessed (see, e.g., FIG. 25).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A computer-implemented method for extracting quantitative summaries of information from digital images, said method comprising the steps of:
(a) performing a first image analysis and one or more additional image analyses, wherein said first image analysis comprises quantitating an image to obtain data from the image, and said one or more additional image analyses comprise modifying said first image analysis or replacing said first image analysis with one or more other image analyses, and wherein performing said one or more additional image analyses comprises quantitating said image to obtain data which may differ from said first image analysis; and
(b) performing a mathematical analysis following completion of said first and said one or more additional image analyses on said data obtained from said first image analysis and from said one or more additional image analyses, or performing a mathematical analysis after each image analysis in step (a) on said data obtained from said first image analysis or from said one or more additional image analyses, wherein said mathematical analysis comprises producing one or more inferences from said data obtained in step (a), said one or more inferences comprising quantitative summaries of information derived from said data.

2. The computer-implemented method of claim 1, further comprising combining two or more mathematical analyses of step (b) to produce one or more combined inferences from said data.

3. The computer-implemented method of claim 1, wherein said performing said first image analysis and said one or more additional image analyses comprise utilizing one or more quantitation algorithms to obtain data from said image.

4. The computer-implemented method of claim 3, wherein said one or more quantitation algorithms comprise calculating and reporting summary statistics on pixel data of said image.

5. The computer-implemented method of claim 1, wherein said performing said first image analysis and said one or more additional image analyses comprise utilizing one or more quantitation algorithms to obtain data from said image, and wherein each of said first image analysis and said one or more additional image analyses additionally comprises one or more of: an image refining algorithm which manipulates pixel data of an original image to obtain a modified image; a geometrization algorithm which establishes a set of regions of interest on said image, which regions of interest delineate a subset of pixels in said image; and a labeling algorithm which assigns labels to data obtained from said image using a quantitation algorithm, which data may be associated with regions of interest.

6. The computer-implemented method of claim 5, wherein said geometrization algorithm comprises one or more of: manual or user-interactive specification of regions of interest, edge detection algorithms, algorithms employing pixel intensity cut-off parameters.

7. The computer-implemented method of claim 5, wherein said labeling algorithm comprises one or more of: manual or user-interactive assignment of labels, importing from an external map.

8. The computer-implemented method of claim 5, wherein said image refining algorithm comprises one or more of: changing an intensity distribution of pixels in the image, changing image properties including hue, saturation, contrast, brightness, tint, color, scale, morphing the image, or reducing image noise.

9. The computer-implemented method of 1, wherein said performing each of said mathematical analyses of step (b) comprises:
(a) specifying a mathematical or statistical model for said data derived from said image;
(b) estimating parameters of said mathematical or statistical model; and
(c) producing said inferences from said parameter estimates.

10. The computer-implemented method of claim 9, wherein said mathematical or statistical model comprises one of: analysis of variance (ANOVA), regression, latent class analysis, or statistical models.

11. The computer-implemented method of claim 1, wherein said method is implemented on a server connected to one or more remotely located computing nodes via a communications network, wherein said method is accessible by said one or more remotely located computing nodes.

12. A computer program product for extracting quantitative summaries of information from digital images, comprising:
a memory medium;
a computer program stored on said medium, said program containing instructions for:
(a) performing a first image analysis and one or more additional image analyses, wherein said first image analysis comprises quantitating an image to obtain data from the image, and said one or more additional image analyses comprise modifying said first image analysis or replacing said first image analysis with one or more other image analyses, and wherein performing said one or more additional image analyses comprises quantitating said image to obtain data which may differ from said first image analysis; and
(b) performing a mathematical analysis following completion of said first and said one or more additional image analyses on said data obtained from said first image analysis and from said one or more additional image analyses, or performing a mathematical analysis after each image analysis in step (a) on said data obtained from said first image analysis or from said one or more additional image analyses, wherein said mathematical analysis comprises producing one or more inferences from said data obtained in step (a), said one or more inferences comprising quantitative summaries of information derived from said data.

13. The computer program product of claim 12, further comprising instructions for combining two or more mathematical analyses of step (b) to produce one or more combined inferences from said data.

14. The computer program product of claim 12, wherein said performing said first image analysis and said one or more additional image analyses comprise utilizing one or more quantitation algorithms to obtain data from said image.

15. The computer program product of claim 14, wherein said one or more quantitation algorithms comprise calculating and reporting summary statistics on pixel data of said image.

16. The computer program product of claim 12, wherein said performing said first image analysis and said one or more additional image analyses comprise utilizing one or more quantitation algorithms to obtain data from said image, and wherein each of said first image analysis and said one or more additional image analyses additionally comprises one or more of: an image refining algorithm which manipulates pixel data of an original image to obtain a modified image; a geometrization algorithm which establishes a set of regions of interest on said image, which regions of interest delineate a subset of pixels in said image; and a labeling algorithm which assigns labels to data obtained from said image using a quantitation algorithm, which data may be associated with regions of interest.

17. The computer program product of claim 16, wherein said geometrization algorithm comprises one or more of: manual or user-interactive specification of regions of interest, edge detection algorithms, algorithms employing pixel intensity cut-off parameters.

18. The computer program product of claim 16, wherein said labeling algorithm comprises one or more of: manual or user-interactive assignment of labels, importing from an external map.

19. The computer program product of claim 16, wherein said image refining algorithm comprises one or more of: changing an intensity distribution of pixels in the image, changing image properties including hue, saturation, contrast, brightness, tint, color, scale, morphing the image, or reducing image noise.

20. The computer program product of 12, wherein said performing each of said mathematical analyses of step (b) comprises:
(a) specifying a mathematical or statistical model for said data derived from said image;
(b) estimating parameters of said mathematical or statistical model; and
(c) producing said inferences from said parameter estimates.

21. The computer program product of claim 20, wherein said mathematical or statistical model comprises one of: analysis of variance (ANOVA), regression, latent class analysis, or statistical models.

22. The computer program product of claim 12, wherein said computer program product is implementable on a server connected to one or more remotely located computing nodes via a communications network.

23. A computer system capable of extracting quantitative summaries of information from digital images, said system comprising: a processor, and a memory medium accessible by said processor, said computer system implementing the functions of:
(a) performing a first image analysis and one or more additional image analyses, wherein said first image analysis comprises quantitating an image to obtain data from the image, and said one or more additional image analyses comprise modifying said first image analysis or replacing said first image analysis with one or more other image analyses, and wherein performing said one or more additional image analyses comprises quantitating said image to obtain data which may differ from said first image analysis; and
(b) performing a mathematical analysis following completion of said first and said one or more additional image analyses on said data obtained from said first image analysis and from said one or more additional image analyses, or performing a mathematical analysis after each image analysis in step (a) on said data obtained from said first image analysis or from said one or more additional image analyses, wherein said mathematical analysis comprises producing one or more inferences from said data obtained in step (a), said one or more inferences comprising quantitative summaries of information derived from said data.

24. The computer system of claim 23, wherein said computer system is further capable of implementing the function of combining two or more mathematical analyses of step (b) to produce one or more combined inferences from said data.

25. The computer system of claim 23, wherein said performing said first image analysis and said one or more additional image analyses comprise utilizing one or more quantitation algorithms to obtain data from said image.

26. The computer system of claim 25, wherein said one or more quantitation algorithms comprise calculating and reporting summary statistics on pixel data of said image.

27. The computer system of claim 23, wherein said performing said first image analysis and said one or more additional image analyses comprise utilizing one or more quantitation algorithms to obtain data from said image, and wherein each of said first image analysis and said one or more additional image analyses additionally comprises one or more of: an image refining algorithm which manipulates pixel data of an original image to obtain a modified image; a geometrization algorithm which establishes a set of regions of interest on said image, which regions of interest delineate a subset of pixels in said image; and a labeling algorithm which assigns labels to data obtained from said image using a quantitation algorithm, which data may be associated with regions of interest.

28. The computer system of claim 27, wherein said geometrization algorithm comprises one or more of: manual or user-interactive specification of regions of interest, edge detection algorithms, algorithms employing pixel intensity cut-off parameters.

29. The computer system of claim 27, wherein said labeling algorithm comprises one or more of: manual or user-interactive assignment of labels, importing from an external map.

30. The computer system of claim 27, wherein said image refining algorithm comprises one or more of: changing an intensity distribution of pixels in the image, changing image properties including hue, saturation, contrast, brightness, tint, color, scale, morphing the image, or reducing image noise.

31. The computer system of 23, wherein said performing each of said mathematical analyses of step (b) comprises:
(a) specifying a mathematical or statistical model for said data derived from said image;
(b) estimating parameters of said mathematical or statistical model; and
(c) producing said inferences from said parameter estimates.

32. The computer system of claim 31, wherein said mathematical or statistical model comprises one of: analysis of variance (ANOVA), regression, latent class analysis, or statistical models.

33. The computer system of claim 23, wherein said system further comprises a server connectable to one or more remotely located computing nodes via a communications network.

34. A computer system for extracting quantitative summaries of information from digital images, comprising:
means for performing a first image analysis and one or more additional image analyses, wherein said first image analysis comprises quantitating an image to obtain data from the image, and said one or more additional image analyses comprise modifying said first image analysis or replacing said first image analysis with one or more other image analyses, and wherein performing said one or more additional image analyses comprises quantitating said image to obtain data which may differ from said first image analysis; and
means for performing a mathematical analysis following completion of said first and said one or more additional image analyses on said data obtained from said first image analysis and from said one or more additional image analyses, or performing a mathematical analysis after each image analysis on said data obtained from said first image analysis or from said one or more additional image analyses, wherein said mathematical analysis comprises producing one or more inferences from said obtained data, said one or more inferences comprising quantitative summaries of information derived from said data.

35. The computer system of claim 34, further comprising means for combining two or more mathematical analyses to produce one or more combined inferences from said data.
